(19) United States
(12) Patent Application Publication
(10) Pub. No.: US 2016/0147416 A1
(43) Pub. Date: May 26, 2016

(54) METHOD AND APPARATUS FOR DETERMINING A REPRESENTATION OF A POINT OF INTEREST BASED ON USER EXPERIENCE

(71) Applicant: HERE Global B.V., Veldhoven (NL)

(72) Inventors: Jane F. MACFARLANE, Oakland, CA (US); Craig R. BARNES, Forest Park, IL (US)

(21) Appl. No.: 14/550,314

(22) Filed: Nov. 21, 2014

(51) Int. Cl. G06F 3/0484; G06F 3/01

(52) U.S. Cl. CPC G06F 3/04845; G06F 3/017

(57) ABSTRACT

An approach is provided for presenting a representation of a point-of-interest in a location-based user interface based on user experience information. A POI representation platform determines interaction information for at least one user, wherein the interaction information is associated with at least one point of interest. The POI representation platform then processes and/or facilitates a processing of the interaction information to determine user experience information with respect to the at least one point of interest. The POI representation platform determines one or more rendering characteristics for at least one representation of the at least one point-of-interest based, at least in part, on the user experience information. The POI representation platform then causes, at least in part, a presentation of the at least one representation of the at least one point-of-interest in a location-based user interface using the one or more rendering characteristics.

### BACKGROUND

Service providers and device manufacturers (e.g., wireless, cellular, etc.) are continually challenged to deliver personalized content and convenience to consumers. One area of interest has been mapping services and other services that depend on maps (e.g., navigation services). As these services become more proliferated, the map elements and related information available for display has increased even more exponentially. Accordingly, service providers and device manufacturers face significant technical challenges to enabling customized representations to display, highlight, or otherwise indicate relevancy of point-of-interests to a user on a map presentation.

### SOME EXAMPLE EMBODIMENTS

Therefore, there is a need for an approach providing representations of point-of-interests that can, for instance, reflect a user's experience with a point-of-interest.

According to one embodiment, a method comprises determining interaction information for at least one user. The interaction information is associated with at least one point of interest. The method also comprises processing and/or facilitating a processing of the interaction information to determine user experience information with respect to the at least one point of interest. The method further comprises determining one or more rendering characteristics for at least one representation of the at least one point-of-interest based, at least in part, on the user experience information. The method comprises causing, at least in part, a presentation of the at least one representation of the at least one point-of-interest in a location-based user interface using the one or more rendering characteristics.

According to another embodiment, an apparatus comprises at least one processor, and at least one memory including computer program code for one or more computer programs, the at least one memory and the computer program code configured to, with the at least one processor, cause, at least in part, the apparatus to determine interaction information for at least one user. The interaction information is associated with at least one point of interest. The method also comprises. The apparatus is also caused to process and/or facilitate a processing of the interaction information to determine user experience information with respect to the at least one point of interest. The apparatus is further caused to determine one or more rendering characteristics for at least one representation of the at least one point-of-interest based, at least in part, on the user experience information. The apparatus is further caused to process to cause at least in part, a presentation of the at least one representation of the at least one point-of-interest in a location-based user interface using the one or more rendering characteristics.

According to another embodiment, a computer-readable storage medium carries one or more sequences of one or more instructions which, when executed by one or more processors, cause, at least in part, an apparatus to determine interaction information for at least one user. The interaction information is associated with at least one point of interest. The method also comprises. The apparatus is also caused to process and/or facilitate a processing of the interaction information to determine user experience information with respect to the at least one point of interest. The apparatus is further caused to determine one or more rendering characteristics for at least one representation of the at least one point-of-interest based, at least in part, on the user experience information. The apparatus is further caused to process to cause at least in part, a presentation of the at least one representation of the at least one point-of-interest in a location-based user interface using the one or more rendering characteristics.

According to another embodiment, an apparatus comprises means determining interaction information for at least one user. The interaction information is associated with at least one point of interest. The apparatus also comprises means for processing and/or facilitating a processing of the interaction information to determine user experience information with respect to the at least one point of interest. The apparatus further comprises a means for determining one or more rendering characteristics for at least one representation of the at least one point-of-interest based, at least in part, on the user experience information. The apparatus comprises a means for causing, at least in part, a presentation of the at least one representation of the at least one point-of-interest in a location-based user interface using the one or more rendering characteristics.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of rendering a representation of a point-of-interest (POI) on a location-based user interface based on user experience, according to one embodiment;

FIG. 2 is a diagram of the components of POI representation platform, according to one embodiment;

FIG. 3 is a flowchart of a process for determining content data to present, according to one embodiment;

FIGS. 4 and 5 are diagrams of user interfaces utilized in the processes of FIG. 3, according to various embodiments;

FIGS. 6A-6D are examples of stylized schemes for the representations according to embodiments;

FIG. 7 is a diagram of hardware that can be used to implement an embodiment of the invention;

FIG. 8 is a diagram of a chip set that can be used to implement an embodiment of the invention; and

FIG. 9 is a diagram of a mobile terminal (e.g., handset) that can be used to implement an embodiment of the invention.

### DESCRIPTION OF SOME EMBODIMENTS

Examples of a method, apparatus, and computer program for determining a representation of a point-of-interest (POI) to present in a location-based user interface based on user experience are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

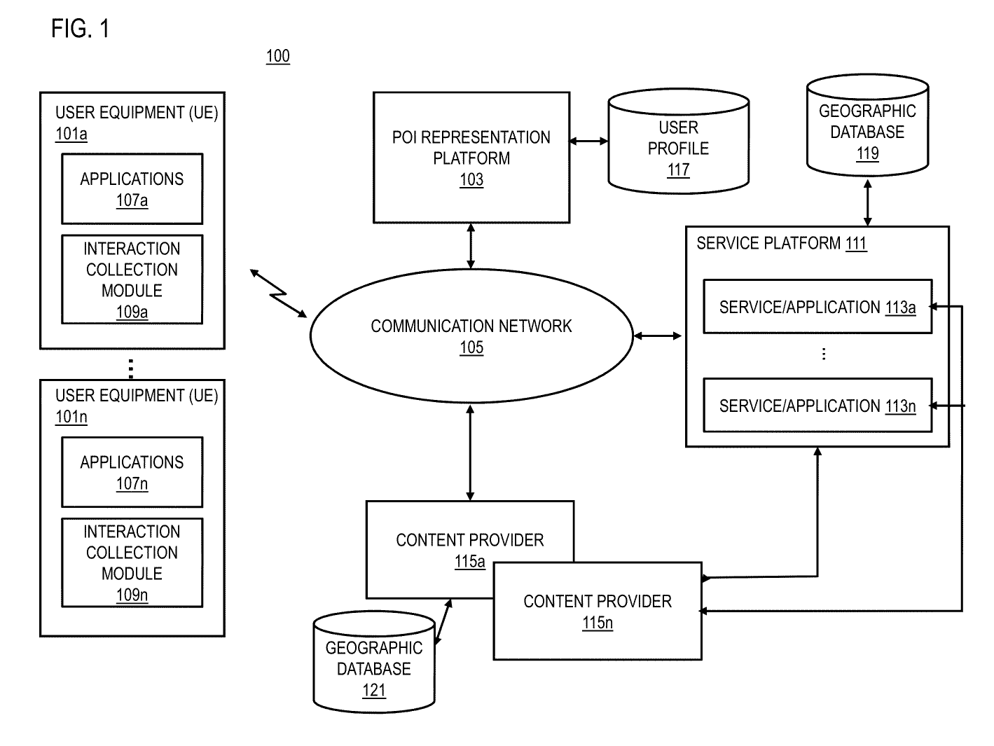

FIG. 1 is a diagram of a system capable of presenting a representation of a point-of-interest (POI) in a location-based user interface based on user experience, according to one embodiment. Traditionally, POIs are presented on mapping applications as building footprints. Additionally, the building footprints may provide access to associated crowd-sourced reviews. However, the crowd-sourced reviews may not reflect the user's own personal history with a POI. The crowd-source reviews and/or the building footprints provide no indication of a user's past experience with a POI.

To address this problem, a system 100 of FIG. 1 introduces the capability to present a representation of a POI in a location-based user interface based on determined user experience. More specifically, the system 100 renders a representation of a POI that visually captures a user experience and/or a continuum of user experiences with the POI over a period. By way of example, the color, size, and/or texture of the representation can reflect positive and/or negative user experience (e.g., like or dislike input). For example, a POI having many “likes” may have a representation that has sparkle indicator and a POI having many “dislikes” may have a dark color. In this way, the system 100 can efficiently and conveniently provide a visualization of user experiences with POIs and thereby provide visibility of valuable information to the user in a location-based user interface. Moreover, the system 100 can store and process user experience information over time and then adjust the representation of the POI by adjusting the one or more rendering characteristics.

In one embodiment, the location-based interface may be any map user interface. The map user interface may include but is not limited to an augmented reality view, a simulated 3D environment, a 2D map, or the like. The POI may be any location at which any activity, building, establishment, or the like may be situated.

In one embodiment, the system 100 determines a representation of a POI based on one or more rendering characteristics. In one embodiment, the one or more rendering characteristics may include but are not limited to size, color, texture, animation style, among others, or a combination thereof. In one embodiment, the one or more rendering characteristics may be based on a stylized theme, for example, selected from one or more stylized themes (e.g., fonts, font sizes, icons, models, color palettes/schemes, or a combination thereof) selected for representation and/or the location-based user interface.

In one embodiment, the system 100 determines the one or more rendering characteristics based on user experience information. For example, the user experience information may include positive and/or negative user experience. A positive user experience may be expressed as a “like” input, “recommend” input, etc., and a negative user experience may be expressed as a “dislike” input, “do not recommend” input, etc., with the associated POI. By way of example, a POI with many likes may be larger, different color, sparkling, among others, or a combination thereof, as compared to a POI with many dislikes. For example, a POI with many dislikes may be of a darker color, smaller, among others, or a combination thereof.

In one embodiment, the system 100 processes interaction information to determine user experience information with respect to at least one POI. As used in the descriptions of the various embodiments described herein, the interaction information associated with at least one POI includes any type of transaction with the point of interest collected and/or received directly and indirectly by the user device, service provider, and/or application. By way of example, the interaction information may be received by user input, for example, a touch interaction, a gesture interaction, a voice interaction, sensor information indicating a physical manipulation of a device presenting the location-based user interface, or a combination thereof with the POI in the location-based user interface. For example, the user input may be a gesture input, such as swiping performed on the representation of the POI in a direction to indicate like or dislike input.

In one embodiment, the system 100 compiles interaction information over a period of time, so that the user experience information and the one or more rendering characteristics may be updated. By way of example, the icons may change size (e.g., grow larger) or increase animation (e.g., sparkling) to indicate many likes at that POI over time. In this way, the representation of the POI can highlight continued “like” experience over time.

In one embodiment, the system 100 can process user experience information for at least one other user associated with the POI and causes a presentation of the representation of the POI based on the other user experience. For example, the system 100 can show the other user experience in a blended representation with the user experience, in a merged representation with the user experience, among others, or a combination thereof. By way of example, user experience for a user and a colleague for a POI on the user's location-based user interface can be represented as a blended color (e.g., representation for the POI may be purple—the representation for user only is blue and the representation for the colleague is red) or as a merged representation (e.g., circles—one circle representation for the user and one circle representation for the colleague).

In one embodiment, the system 100 can calculate a route to a destination based, at least in part, on the user experience information. For example, the system 100 can calculate a route with POI(s) corresponding to the user's favorites (e.g., like input) or similar to the user's favorites, a route avoiding POI(s) corresponding to user's least favorites (dislike input) or similar to the user's least favorites. In this way, the system 100 can personalize the route to a destination to the user.

In one embodiment, the system 100 can determine one or more recommendations based on the user experience information, the at least POI associated with the user experience information, or a combination thereof. The recommendations may be other point-of-interests, coupons, ads, among others, or a combination thereof. For example, the system 100 can determine recommendations for a restaurant near the destination based on the user experience (e.g., like inputs). In this way, the system 100 can efficiently and conveniently provide recommendations to a user without requiring the user to access and search crowd-sourced reviews. In another example, the recommendations may be presented on the location-based interface as ads and/or coupons to help entice the user to visit.

In one embodiment, the system 100 can determine contextual information (e.g., temporal information, activity information, presence information, among others, or a combination thereof) to determine, at least in part, the interaction information, the user experience, the presentation, among others, or a combination thereof. By way of example, a user uploading one or more photos associated with the POI for sharing may be processed as a “like” input by the system 100. In another example, the amount of money left as a tip may be an indicator of “like” input.

In one embodiment, the system 100 can filter the representations presented on location-based user interface based on user input. For example, the user can filter the representations based on time, number of visits, and the like. By way of example, the user may like a restaurant only for lunch and dislike the restaurant for dinner. In this way, the user can easily distinguish preferences (liked or disliked) of POIs based on time.

As shown in FIG. 1, the system 100 comprises one or more user equipment (UEs) 101a-101n (also collectively referred to as UEs 101) having connectivity to a POI representation platform 103 via a communication network 105. The UEs 101 may include or have access to an application 107 (or applications 107), which may consist of client programs, services, or the like that may utilize the POI representation platform 103, or other services, applications, content, etc. available over the communication network 105.

In one embodiment, interaction information associated with a POI can be collected and monitored at the POI representation platform 103. In certain embodiments, the application 107 on the UE 101 can receive interaction information associated with an interaction collection module 109 of the UE 101. For example, the interaction collection module 109 may utilize applications, services, sensors, etc., to collect such information, as well as contextual information. Information may include, for instance, location information, camera information, compass information, user calendar information, accelerometer information, financial transaction information, etc. In one embodiment, the interaction collection module 109 may have connectivity to a location determination sensor system, such as a Global Positioning System (GPS) to access GPS satellites to determine e.g., location of the UE 101. The UE 101 may then cause transmission of the collected contextual information (e.g., the profile information, location information etc.) to the platform 103 for processing to determine user interaction information and/or user experience information associated with a POI.

In one embodiment, the POI representation platform 103 can receive and store interaction information and/or user experience information in a user profile associated with the user in a user profile database 117. In certain embodiments, the user profile may include an identifier of the user (e.g., a username) and/or an identifier of the UE 101 (e.g., a hardware identifier such as International Mobile Equipment Identity (IMEI), a phone number, an Internet Protocol address, etc.

In one embodiment, the system 100 may employ one or more stylized themes to the one or more rendering characteristics representation of the POI. In one embodiment, the system 100 may employ one baseline representation of a POI with no user experience information on the location-based user interface. For example, a POI with no user experience may be filled with white or no color, and the color may change to a brighter or darker color based on the user experience information.

In other words, the system 100 defines or provides categories of one or more map elements to reflect at least partly an appearance or rendering characteristic of the map element or item. Then, the system 100 converts at least partly the predefined appearance of the map elements in the affected categories to an appearance corresponding to a selected a map display (e.g., a map display corresponding to a mode of transport and/or associated context information).

In one embodiment, the POI representation platform 103 can obtain content information for rendering the representation of a POI. The content, for instance, includes text information, location information of other user devices, mapping data, geo-tagged data (e.g., indicating locations of people, objects, images, etc.), coupons, ads, among others, or a combination thereof. The content may be provided by the service platform 111 which includes one or more services 113a-113 n (e.g., mapping service, content broadcasting service, etc.), the one or more content providers 115 a-115 n (e.g., online content retailers, public databases, etc.), other content source available or accessible over the communication network 105. In one embodiment, content is delivered from the content providers 115 a-115 n to the UE 101 through the service platform 111 and/or the services 113 a-113 n. For example, a service 113 a (e.g., a mapping service) may obtain content (e.g., map content) from a content provider 115 a to deliver location-based user interface to the UE 101.

In one embodiment, the service platform 111 and/or the content provider 115 may obtain the map content for the location-based user interface from a geographic database 119/121 The geographic database 119/121 includes node data records, road segment or link data records, POI data records, and other data records. More, fewer or different data records can be provided. In one embodiment, the other data records include cartographic (“carto”) data records, routing data, and maneuver data. One or more portions, components, areas, layers, features, text, and/or symbols of the POI can be stored in, linked to, and/or associated with one or more of these data records. For example, one or more portions of the POI, event data, or recorded route information can be matched with respective map or geographic records via position or GPS data associations (such as using known or future map matching or geo-coding techniques), for example.

In exemplary embodiments, the road segment data records are links or segments representing roads, streets, or paths, as can be used in the calculated route or recorded route information for determination of one or more personalized routes, according to exemplary embodiments. The node data records are end points (that may represent intersections) corresponding to the respective links or segments of the road segment data records. The road link data records and the node data records represent a road network, such as used by vehicles, cars, and/or other entities. Alternatively, the geographic database 119/121 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 119/121 can include data about the POIs and their respective locations in the POI data records. The geographic database 119/121 can also include data about places, such as cities, towns, or other communities, and other geographic features, such as bodies of water, mountain ranges, etc. Such place or feature data can be part of the POI data or can be associated with POIs or POI data records (such as a data point used for displaying or representing a position of a city). In addition, the geographic database 119/121 can include event data (e.g., traffic incidents, constructions, scheduled events, unscheduled events, etc.) associated with the POI data records or other records of the geographic database 119/121.

The geographic database 119/121 can be maintained by the content provider 115 (e.g., a map developer) in association with the services platform 111. By way of example, the map developer can collect geographic data to generate and enhance the geographic database 119/121. There can be different ways used by the map developer to collect data. These ways can include obtaining data from other sources, such as municipalities or respective geographic authorities. In addition, the map developer can employ field personnel to travel by vehicle along roads throughout the geographic region to observe features and/or record information about them, for example. Also, remote sensing, such as aerial or satellite photography, can be used.

The geographic database 119/121 can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a UE 101, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

As mentioned above, the server side geographic database 119 can be a master geographic database, but in alternate embodiments, the client side geographic database 121 can represent a compiled navigation database that can be used in or with end user devices (e.g., UEs 101) to provide the location-based user interface, as well as navigation and/or map-related functions. For example, the geographic database 121 can be used with the end UE 101 to provide an end user with navigation features. In such a case, the geographic database 121 can be downloaded or stored on the end user device UE 101, such as in applications 107, or the end user device UE 101 can access the geographic database 121 and/or 119 through a wireless or wired connection (such as via a server and/or the communication network 105), for example.

In certain embodiments, the location-based user interface presented to the user may be an augmented reality view, a simulated 3D environment (e.g., 3D model created to approximate the locations of streets, buildings, features, etc.

In one embodiment, the application 107 can present content information, location information (e.g., location-based user interface and navigation information), etc. to the user. The user may be presented with an augmented reality interface associated with the application 107 and/or representations of the POI and related information superimposed onto an image of a physical environment on the UE 101.

By way of example, the UE 101 may execute the application 107 to receive POI representation(s) and/or location-based user interface from the POI representation platform 103 or other component of the network 105. As mentioned above, the application 107 and/or POI representation platform 103 renders a map display in which POI are represented based on one or more rendering characteristics based on user experience information.

By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

In one embodiment, the end user device or UE 101 can be an in-vehicle navigation system, a personal navigation device (PND), a portable navigation device, a cellular telephone, a mobile phone, a personal digital assistant (PDA), a watch, a camera, a computer, and/or other device that can perform navigation-related functions, such as digital routing and map display. In one embodiment, the navigation device UE 101 can be a cellular telephone. An end user can use the device UE 101 for navigation and map functions, such as guidance and map display, on the location-based user interface for example, and for determination of one or more personalized routes or route segments based on one or more calculated and recorded routes, according to exemplary embodiments.

By way of example, the UEs 101 and POI representation platform 103 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

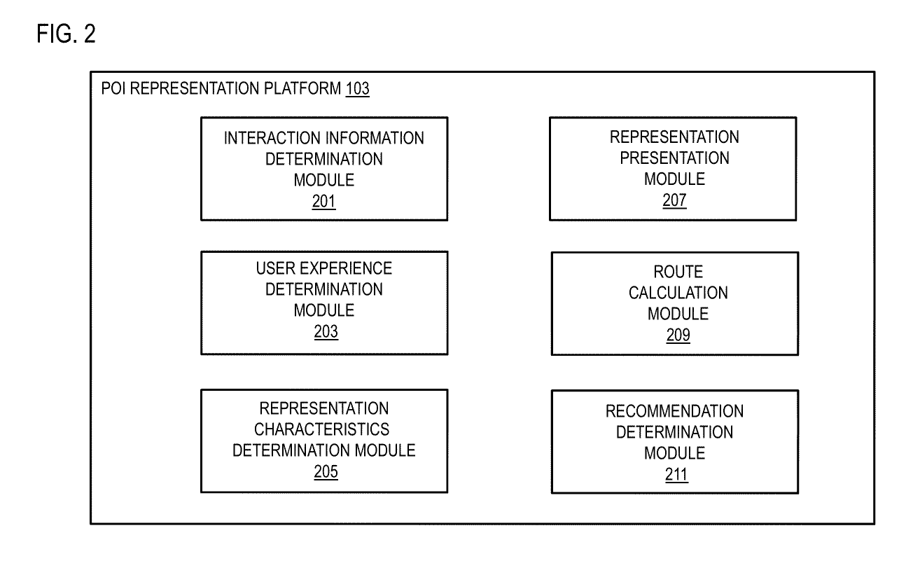

FIG. 2 is a diagram of the components of the POI representation platform 103 according to one embodiment. By way of example, the POI representation platform 103 includes one or more components for determining one or more rendering characteristics for a representation of a POI in a location-based user interface based on user experience information. It is contemplated that the functions of these components may be combined in one or more components or performed by other components of equivalent functionality. In this embodiment, the POI representation platform 103 includes an interaction information determination module 201, a user experience determination module 203, a representation characteristics determination module 205, a representation presentation module 207, a route calculation module 209, and a recommendation determination module 211. It is contemplated that all or a portion of the functions of POI representation platform 103 may be performed by the application 107 of the UE 101.

In one embodiment, the interaction information determination module 201 may receive, determine, and/or monitor interaction information associated with at least one point of interest. In one embodiment, the interaction information determination module 201 can receive user inputs in the location-based user interface to indicate a like input and/or a dislike input. For example, the user input may indicate like input by swiping upward and may indicate a dislike input by swiping downward. In one embodiment, the interaction information determination module 201 may receive contextual information from the interaction collection module 109 from which interaction information can be determined. For example, the interaction collection module 109 may determine that a recent purchase was made at a restaurant, and the amount of tip may be used by the interaction information determination module 201 to determine whether it is a like input or dislike input. In this example, a high tip may be an indicator of a like and a low tip may be an indicator of a dislike.

The user experience determination module 203 can process the interaction information to determine the user experience information. In the example above, the user experience determination module 203 may process an upward swipe as a “like” and a downward swipe as a “dislike.” In one embodiment, the user experience determination module 203 may additionally and/or alternatively access the user experience and/or interaction information, including history of user experience/interaction with a POI, from the user profile database 117.

In one embodiment, the interaction information determination module 201 and/or the user experience determination module 203 can store interaction information and/or user experience information in a user profile in the user profile database 117. In this way, the user can record experiences, like a journal.

In one embodiment, the interaction information and/or the user interaction information may be stored with contextual information. For example, the interaction information and/or the user interaction information may be stored with temporal information. By way of example, the temporal information may further distinguish between experiences, for example, a restaurant's lunch service and a restaurant's dinner service.

In one embodiment, the representation characteristics determination module 205 may determine one or more rendering characteristics for the at least one representation of the POI based on the user experience information. The one or more rendering characteristics may include but are not limited to size, color, animation, texture, among others or a combination thereof. In one embodiment, the one or more rendering characteristics may be based on a stylized scheme. In one example, the representation characteristics determination module 205 may determine the one or more rendering characteristics based on a single visit. By way of example, the representation characteristics determination module 205 may modify the one or more rendering characteristics of a basic default representation of a POI based on the user experience. For example, the user indicates a “like” for his first visit to a restaurant and the representation characteristics determination module 205 may determine that the representation for that restaurant should change from a white filled icon to a blue-filled icon. In another example, the representation characteristics determination module 205 may determine the one or more rendering characteristics based on the user's history with the POI. For example, the user has indicated his fourth “like” for that restaurant and the representation characteristics determination module 205 may determine that the representation for that restaurant should change from a blue-filled icon to a sparkling blue-filled icon.

In one embodiment, the representation characteristics determination module 205 may determine the one or more rendering characteristics based on other user experience information with the point of interest. For example, the representation characteristics determination module 205 may take into account other users near the user, for example, other individuals of the user's dinner meeting. The representation characteristics determination module 205 may determine the one or more rendering characteristics for the other user(s) based on the associated user experience information.

In one embodiment, the representation presentation module 207 can cause a presentation of the at least one representation of the at least one POI in a location-based user interface using the one or more rendering characteristics determined by the representation characteristics determination module 205. For example, in the example above, the representation presentation module 207 may cause the representation for the restaurant to be sparkling. In this way, the representation for the restaurant can be differentiated from other restaurants that the user either has not visited, disliked, or does not like as much.

In another example, the representation presentation module 207 may cause the presentation of the representation for the POI for the user and another user. For example, the representation presentation module 207 may cause the representations of the user and the other user to blend together as a single color, merging of the representations (e.g., adjacent representations in different layers), among others, or a combination thereof.

In one embodiment, the representation presentation module 207 may cause the presentation of the representation(s) of all POIs associated with a geographic area. In another embodiment, the representation presentation module 207 may cause the presentation of the representations of all POI(s) associated with a geographic area and time of day which the user is viewing the display. In another embodiment, the representation presentation module 207 may cause the presentation of the one or more representations of POIs that satisfy certain criteria inputted by the user. For example, the user may cause the representation presentation module 207 to filter the representations and present those representation(s) having relevant user experience (e.g., user experience within the certain time criteria (e.g., evening)). In one embodiment, the user may input the filter using a slider bar for time on the location-based user interface. In this way, the representation presentation module 207 may cause the representation to change based on different times of the day.

In one embodiment, the route calculation module 209 may calculate a route to a destination based on the user experience information. The route calculation module 209 can take into account the user's interests and/or preferences by computing a route based on the favorite POIs and/or recommendations (e.g., similar POIs to the user's favorite POIs). In addition or in the alternative, the route calculation module 309 can determine a route that avoids the POIs that are disliked by the user.

In one embodiment, the recommendation determination module 211 may be configured to determine recommendations based on the user experience information, the at least one point of interest associated with the user experience information, among others, or a combination thereof. The recommendations may include content (e.g., coupons, ads, etc.), other points or the like. In one embodiment, the recommendation determination module 211 may determine one or more points to be included in the route calculation module 209, for example, by collaborative filtering. By way of example, the user is visiting Chicago, requests a route from his hotel to a theater for show for which he has tickets, and he wants to eat dinner before the show. In this example, the recommendation determination module 211 may determine one or more restaurants near the theater that are similar to his favorite restaurants back home (as indicated by his like user interaction) and cause representations of those recommended restaurants to be presented in the location-based user interface along the route. The one or more rendering characteristics may be different from those and/or similar to those used to indicate well-liked restaurants. In another example, the recommendation determination module 211 can cause content to be presented in addition and or in alternative to the representation.

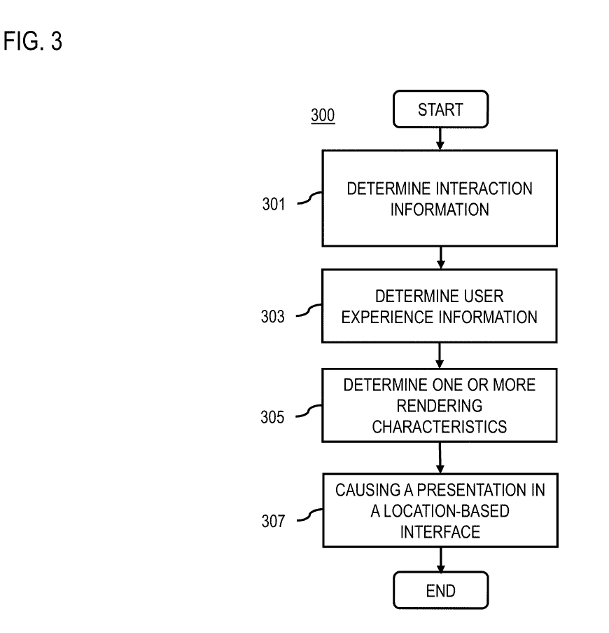

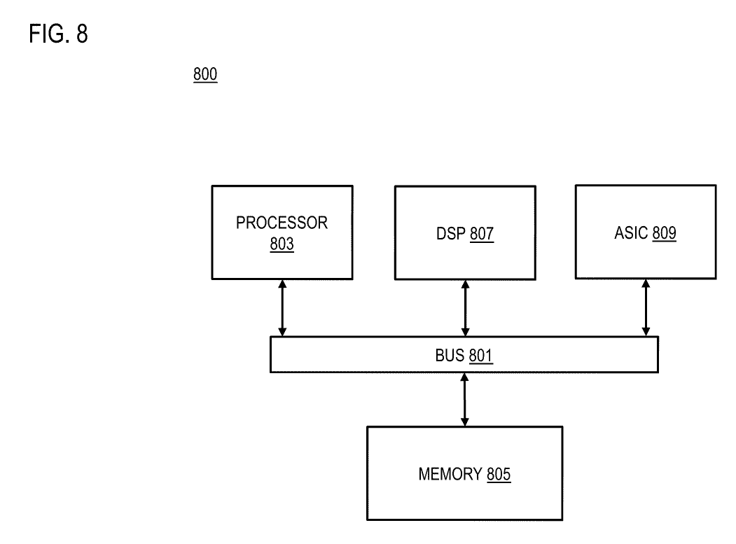

FIG. 3 is a flowchart of a process for determining one or more representations of at least one POI to present in the location-based user interface based on determined user experience, according to one embodiment. In one embodiment, the POI representation platform 103 and/or an application 107 of the UE 101 performs the process 300 and is implemented in, for instance, a chip set including a processor and a memory as shown in FIG. 8. Throughout this process, the POI representation platform 103 is referred to as completing various portions of the process 300, however it is understood that the UE 101 can perform some of and/or all of the process steps.

In step 301, the POI representation platform 103 determines interaction information associated with at least one POI. In one embodiment, the determination of the interaction information is based on received user input information with respect to the at least one POI on the location-based user interface. In one example, the user swipes on the representation in the user interface using one or more fingers or gestures a swiping motion on the user representation in a direction (e.g., upward) for a like input and in the opposite direction (e.g., downward) for a dislike input. In another example, the location-based user interface may present buttons indicating like/dislike for interaction information. In another yet example, the user verbally indicates like and/or dislike input with respect to the POI representation. In yet another example, the POI representation platform 103 determines interaction information from contextual information. For example, the POI representation platform 103 determines interaction information from other user's interaction with the POI, such as loading and sharing photos, financial transactions (e.g., purchase and/or tipping amounts), location and/or time tracking at the POI, among others, or a combination thereof. In one embodiment, the POI representation platform 103 may store the interaction information in the user profile database 117.

The POI representation platform 103 then processes the user interaction information to determine user experience information with respect to the at least one point of interest (step 303). In one embodiment, the user experience information may indicate like/dislike input and related time period (e.g., morning, mid-day, evening, etc.). In one example, the POI representation platform 103 may compile user experience information over a period of time so as to determine a historical overview of user experience (e.g., continued likes and/or dislikes) with the POI.

The POI representation platform then determines one or more rendering characteristics for at least one representation based on at least the POI (step 305). In some embodiments, the one or more rendering characteristics may be based on a stylized scheme associated with the user and/or location-based user interface. For example, the user may indicate the stylized scheme in the user profile in the profile database 117. The like and/or continued like of a location may be indicated in the one or more rendering characteristics, for example, by getting larger, becoming animated (e.g., sparkling), and/or changing color. The dislike and/or continued dislike may also be indicated in the one more rendering characteristics, for example, by getting smaller, changing texture (e.g., fading away), and/or changing color.

In one embodiment, the POI representation platform performs the steps 301-303 for at least user. In another embodiment, the POI representation platform 103 performs the steps 301-303 for other users, for example, nearby the user. For example, the POI representation platform 103 can perform the steps 301-303 for the user's spouse, significant other, friends, as well as other people that have had experience at the POI. In one example, each of the other users may be represented by different color. In another example, the representations for the user and each of the other users may be disposed at a different layer so that the representations may be a merged representation in the location-based user interface (e.g., concentric circles). In yet another example, the representations for the user and each of the other users may be combined in the location-based user interface (e.g., blended colors). In this way, the POI representation platform 103 can conveniently capture preferences personal to the user rather than generic preferences provided by the crowd source website.

After the one or more rendering characteristics are determined, the POI representation platform 103 causes a presentation of the representation(s) in the location-based interface using the one or more rendering characteristics (step 307). In one embodiment, the representations may be presented along with a route to a destination. In yet another embodiment, the representations may also be presented with recommendations and/or other content (e.g., ads or coupons) in the location-based user interface.

In yet another example, the POI may be filtered based on criteria and the representations may presented in the location-based user interface for POI that satisfy that criteria. By way of example, a user who is looking for one or more restaurants for breakfast may cause the POI representation platform 103 to present only the representations for POI having user experience associated with that time period (e.g., morning).

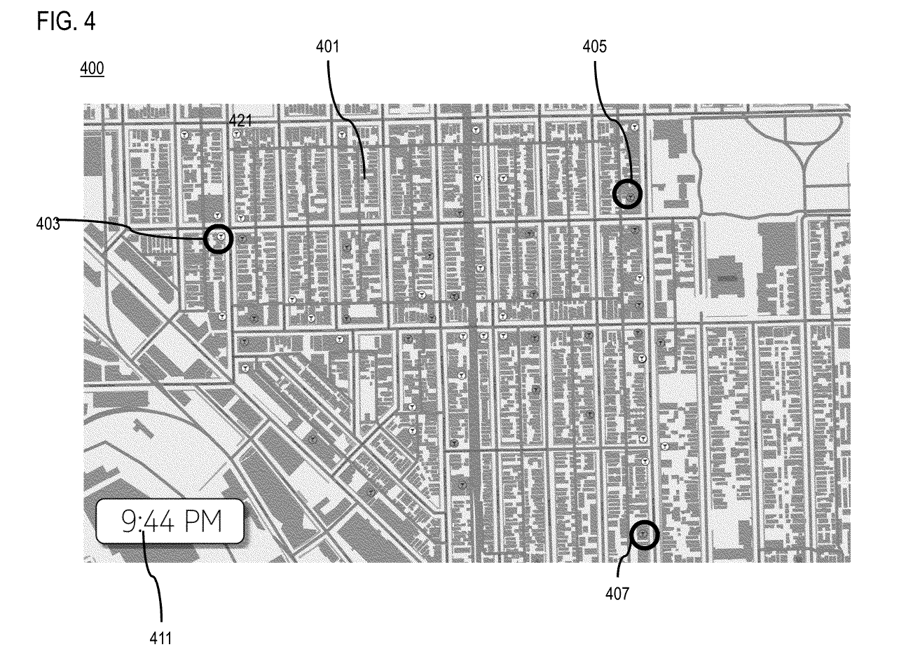

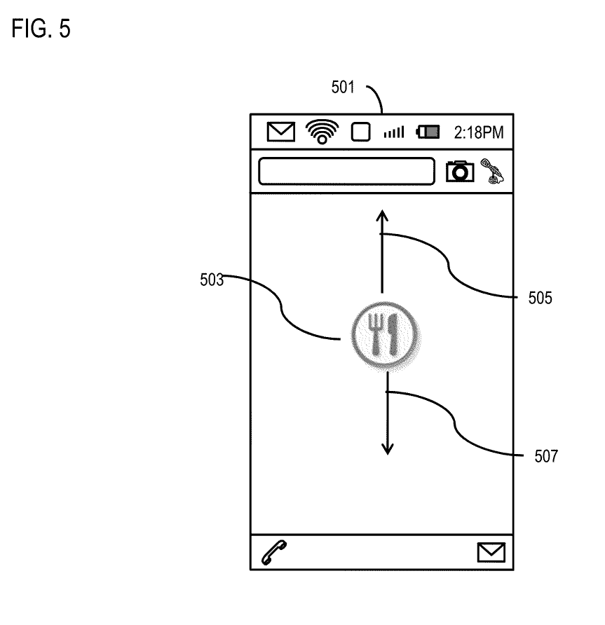

FIGS. 4 and 5 are diagrams of user interfaces utilized in the process of FIG. 3, according to various embodiments. FIG. 4 shows an example of a location-based user interface 400 with unfiltered representations for POI for presented. The representations of POI are presented on the location-based user interface 401. In this example, the representations can indicate positive user experience, negative user experience, or no user experience by way of color. The POIs with no user experience information and/or interaction information are presented with no color (white and/or transparent), for example, representation 403. The POIs with positive user experience information and/or interaction information (e.g., like input) are presented with a specific color (e.g., blue), for example, representation 405. The POIs with negative user experience information and/or interaction information (e.g., dislike input) are presented with a specific color (e.g., red), for example, representation 407.

FIG. 5 shows an example of a location-based user interface 501 configured to receive interaction information associated with at least on POI for a user by user input. In this example, the user input may be a gesture motion to swipe the representation 503 of the POI either upward motion 505 or downward motion 507. In this example, the upward motion may indicate positive experience (e.g., a like input) and the downward motion may indicate negative experience (e.g., a dislike input). The number of positive and/or negative experiences may be reflected in the one or more rendering characteristics used to cause a representation of the POI to be presented.

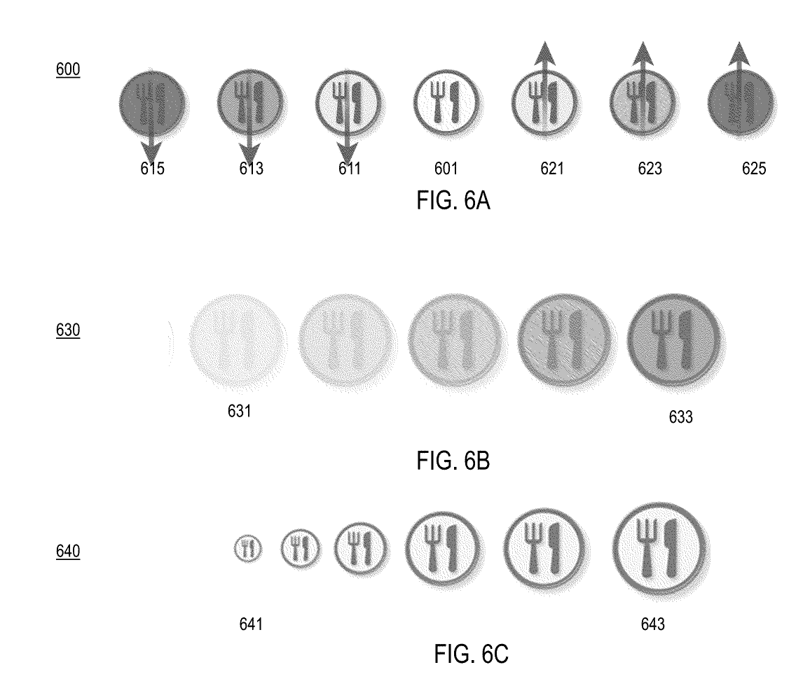

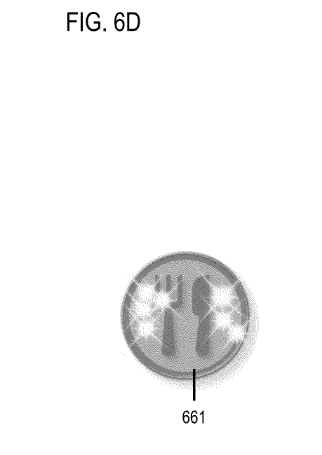

FIGS. 6A-6D show different examples of stylistic schemes for indicating historical user experience. FIG. 6A shows example 600 of a color scheme, for example, that may be used for the one or more rendering characteristics of the representation provide din the example in FIG. 5. In this example, the color changes and becomes deeper as there are multiple positive and/or negative user experiences. In this example, the representation 601 for the POI with no user experience may be white or no color, for example, as shown in representation 503 in FIG. 5. In this example, the positive user experience may be reflected by an upward swipe gesture and represented by a specific color, and negative user experience may be reflected by a downward swipe gesture and represented by a different color. As shown in FIG. 6A, the representation for at least one positive experience (e.g., like input) may be reflected in representation 621. The more positive user experiences, the deeper the color of the representation, for example, as shown in representations 623 and 625. Similarly, the representation for at least one negative experience (e.g., dislike input) may be reflected in representation 611. The more negative user experiences, the deeper the color of the representation, for example, as shown in representations 613 and 615.

FIGS. 6B-6D show examples of other stylistic schemes for the representations. FIG. 6B shows a transparency stylistic scheme. For example, the representation may have a baseline like representation 633 (e.g., no user experience) and may become more transparent through representation 631 based on the number of negative user experiences (e.g., dislike input). In alternative example, the representation may have a baseline like representation 631 and may become deeper in color based on the number of positive and/or negative user experiences.

FIG. 6C shows a stylistic scheme in which the representation gets bigger based on the number of positive user experiences (e.g., like inputs). For example, the representation may have a baseline like representation 641 and may enlarge through representation 643 based on the number of positive user experiences.

In another example, based on the number of positive user experiences for the user and/or other users, the POI representation platform 103 may determine that the representation should become animated, like representation 661 shown in FIG. 6D. In this example, the representation 661 may appear to be sparkling.

The processes described herein for determining a representation of a point-of-interest (POI) to present in a location-based user interface based on user experience may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

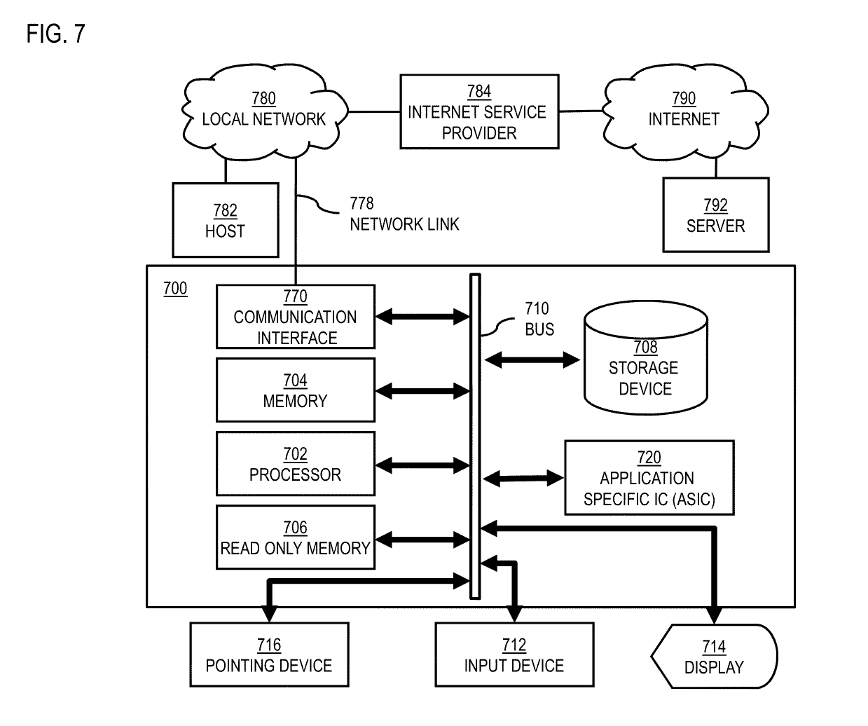

FIG. 7 illustrates a computer system 700 upon which an embodiment of the invention may be implemented. Although computer system 700 is depicted with respect to a particular device or equipment, it is contemplated that other devices or equipment (e.g., network elements, servers, etc.) within FIG. 7 can deploy the illustrated hardware and components of system 700. Computer system 700 is programmed (e.g., via computer program code or instructions) to determine a representation of a point-of-interest (POI) to present in a location-based user interface based on user experience as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 700, or a portion thereof, constitutes a means for performing one or more steps of to determine a representation of a point-of-interest (POI) to present in a location-based user interface based on user experience.

A bus 710 includes one or more parallel conductors of information so that information is transferred quickly among devices coupled to the bus 710. One or more processors 702 for processing information are coupled with the bus 710.

A processor (or multiple processors) 702 performs a set of operations on information as specified by computer program code related to determine a representation of a point-of-interest (POI) to present in a location-based user interface based on user experience. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or any other dynamic storage device, stores information including processor instructions for determining a representation of a point-of-interest (POI) to present in a location-based user interface based on user experience. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or any other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions to determine a representation of a point-of-interest (POI) to present in a location-based user interface based on user experience, is provided to the bus 710 for use by the processor from an external input device 712, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT), a liquid crystal display (LCD), a light emitting diode (LED) display, an organic LED (OLED) display, a plasma screen, or a printer for presenting text or images, and a pointing device 716, such as a mouse, a trackball, cursor direction keys, or a motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of ASICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 105 for determining content data to present to the UE 101.

The term “computer-readable medium” as used herein refers to any medium that participates in providing information to processor 702, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 708. Volatile media include, for example, dynamic memory 704. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 720.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system 700 can be deployed in various configurations within other computer systems, e.g., host 782 and server 792.

At least some embodiments of the invention are related to the use of computer system 700 for implementing some or all of the techniques described herein. According to one embodiment of the invention, those techniques are performed by computer system 700 in response to processor 702 executing one or more sequences of one or more processor instructions contained in memory 704. Such instructions, also called computer instructions, software and program code, may be read into memory 704 from another computer-readable medium such as storage device 708 or network link 778. Execution of the sequences of instructions contained in memory 704 causes processor 702 to perform one or more of the method steps described herein. In alternative embodiments, hardware, such as ASIC 720, may be used in place of or in combination with software to implement the invention. Thus, embodiments of the invention are not limited to any specific combination of hardware and software, unless otherwise explicitly stated herein.

The signals transmitted over network link 778 and other networks through communications interface 770, carry information to and from computer system 700. Computer system 700 can send and receive information, including program code, through the networks 780, 790 among others, through network link 778 and communications interface 770. In an example using the Internet 790, a server host 792 transmits program code for a particular application, requested by a message sent from computer 700, through Internet 790, ISP equipment 784, local network 780 and communications interface 770. The received code may be executed by processor 702 as it is received, or may be stored in memory 704 or in storage device 708 or any other non-volatile storage for later execution, or both. In this manner, computer system 700 may obtain application program code in the form of signals on a carrier wave.

Various forms of computer readable media may be involved in carrying one or more sequence of instructions or data or both to processor 702 for execution. For example, instructions and data may initially be carried on a magnetic disk of a remote computer such as host 782. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to a signal on an infra-red carrier wave serving as the network link 778. An infrared detector serving as communications interface 770 receives the instructions and data carried in the infrared signal and places information representing the instructions and data onto bus 710. Bus 710 carries the information to memory 704 from which processor 702 retrieves and executes the instructions using some of the data sent with the instructions. The instructions and data received in memory 704 may optionally be stored on storage device 708, either before or after execution by the processor 702.

FIG. 8 illustrates a chip set or chip 800 upon which an embodiment of the invention may be implemented. Chip set 800 is programmed to determine a representation of a point-of-interest (POI) to present in a location-based user interface based on user experience as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 800 can be implemented in a single chip. It is further contemplated that in certain embodiments the chip set or chip 800 can be implemented as a single “system on a chip.” It is further contemplated that in certain embodiments a separate ASIC would not be used, for example, and that all relevant functions as disclosed herein would be performed by a processor or processors. Chip set or chip 800, or a portion thereof, constitutes a means for performing one or more steps of providing user interface navigation information associated with the availability of functions. Chip set or chip 800, or a portion thereof, constitutes a means for performing one or more steps of determining a representation of a point-of-interest (POI) to present in a location-based user interface based on user experience.

In one embodiment, the chip set or chip 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 800 includes merely one or more processors and some software and/or firmware supporting and/or relating to and/or for the one or more processors.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to determine a representation of a point-of-interest (POI) to present in a location-based user interface based on user experience. The memory 805 also stores the data associated with or generated by the execution of the inventive steps.

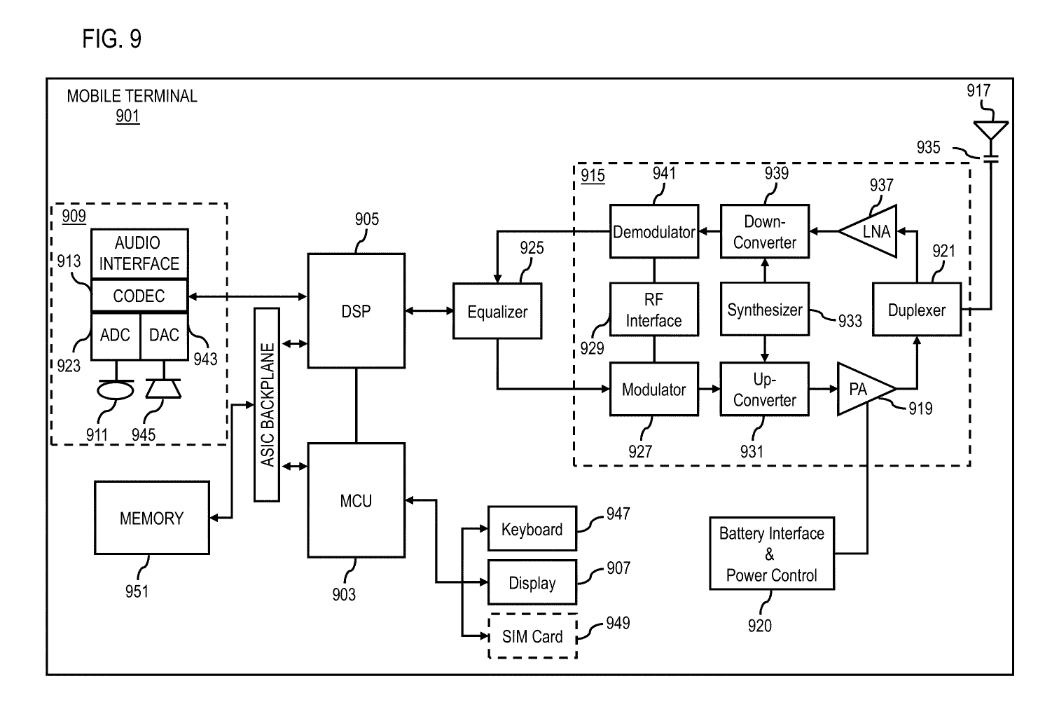

FIG. 9 is a diagram of exemplary components of a mobile terminal (e.g., handset) for communications, which is capable of operating in the system of FIG. 1, according to one embodiment. In some embodiments, mobile terminal 801, or a portion thereof, constitutes a means for performing one or more steps of determining a representation of a point-of-interest (POI) to present in a location-based user interface based on user experience. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile terminal functions that perform or support the steps of determining a representation of a point-of-interest (POI) to present in a location-based user interface based on user experience. The display 907 includes display circuitry configured to display at least a portion of a user interface of the mobile terminal (e.g., mobile telephone). Additionally, the display 907 and display circuitry are configured to facilitate user control of at least some functions of the mobile terminal. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile terminal 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903 which can be implemented as a Central Processing Unit (CPU).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile terminal 901 to determine a representation of a point-of-interest (POI) to present in a location-based user interface based on user experience. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the terminal. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile terminal 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable storage medium known in the art. The memory device 951 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 949 carries, for instance, important information, such as the cellular phone number, the carrier supplying service, subscription details, and security information. The SIM card 949 serves primarily to identify the mobile terminal 901 on a radio network. The card 949 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
determining interaction information for at least one user, wherein the interaction information is associated with at least one point of interest;
processing and/or facilitating a processing of the interaction information to determine user experience information with respect to the at least one point of interest;
determining one or more rendering characteristics for at least one representation of the at least one point-of-interest based, at least in part, on the user experience information; and
causing, at least in part, a presentation of the at least one representation of the at least one point-of-interest in a location-based user interface using the one or more rendering characteristics.

2. A method of claim 1, further comprising:
receiving the interaction information by at least one user input in the location-based user interface, one or more interactions with at least one service or at least one application executing on at least one device associated with the at least one user, or a combination thereof.

3. A method of claim 2, wherein the at least one user input includes at least one gesture interaction, wherein the at least one gesture interaction that is an upward swipe gesture performed on the at least one representation indicates a like input for the user experience information, and wherein the at least one gesture interaction that is a downward swipe gesture that is performed on the at least one representation indicates a dislike input for the user experience information.

4. A method of claim 1, further comprising:
causing, at least in part, a compilation of the user experience information over a period of time,
wherein each instance of the interaction information determined over the period of time results in an updating of the user experience information and the one or more rendering characteristics.

5. A method of claim 1, further comprising:
determining other user experience information for at least one other user, wherein the other user experience information is associated with at least one point-of-interest;
determining one or more other rendering characteristics for at least one other representation of the at least one point-of-interest; and
causing, at least in part, a presentation of the at least one representation using the one or more rendering characteristics in combination with the at least one other representation using the one or more other rendering characteristics in the location-based user interface.

6. A method of claim 5, wherein the presentation of the at least one representation in combination with the at least one other representation comprises at least one of:
a presentation of the at least one representation in a first layer of the location-based user interface, and a presentation of the at least one other representation in a second layer of the location-based user interface; and
a merging of the at least one representation with the at least one other representation to cause, at least in part, generation of at least one merged representation for presentation in the location-based user interface.

7. A method of claim 1, further comprising:
receiving a request from the at least one user to calculate at least one route; and
causing, at least in part, a calculation of the route based, at least in part, on the user experience information.

8. A method of claim 1, further comprising:
determining at least one recommendation of one or more other points based, at least in part, on the user experience information, the at least one point of interest associated with the user experience information, or a combination thereof.

9. A method of claim 1, wherein the interaction information, the user experience information, the presentation of the at least one representation in the location-based user interface, or a combination thereof is based, at least in part, on contextual information; and wherein the contextual information includes, at least in part, temporal information, activity information, presence information of at least one other user, or a combination thereof.

10. A method of claim 1, wherein the at least one location-based user interface is a map user interface, and wherein the at least one representation, the one or more rendering characteristics, or a combination thereof is based, at least in part, on one or more stylized themes selected for the map user interface.

11. An apparatus comprising:
at least one processor; and
at least one memory including computer program code for one or more programs,
the at least one memory and the computer program code configured to, with the at least one processor, cause the apparatus to perform at least the following,
determine interaction information for at least one user, wherein the interaction information is associated with at least one point of interest;
process and/or facilitate a processing of the interaction information to determine user experience information with respect to the at least one point of interest;
determine one or more rendering characteristics for at least one representation of the at least one point-of-interest based, at least in part, on the user experience information; and
cause, at least in part, a presentation of the at least one representation of the at least one point-of-interest in a location-based user interface using the one or more rendering characteristics.

12. An apparatus of claim 11, wherein the apparatus is further caused to:
receive the interaction information by at least one user input in the location-based user interface, one or more interactions with at least one service or at least one application executing on at least one device associated with the at least one user, or a combination thereof.

13. An apparatus of claim 12, wherein the at least one user input includes at least one gesture interaction, wherein the at least one gesture interaction that is an upward swipe gesture performed on the at least one representation indicates a like input for the user experience information, and wherein the at least one gesture interaction that is a downward swipe gesture that is performed on the at least one representation indicates a dislike input for the user experience information.

14. An apparatus of claim 11, wherein the apparatus is further caused to:
determine other user experience information for at least one other user, wherein the other user experience information is associated with at least one point-of-interest;
determine one or more other rendering characteristics for at least one other representation of the at least one point-of-interest; and
cause, at least in part, a presentation of the at least one representation using the one or more rendering characteristics in combination with the at least one other representation using the one or more other rendering characteristics in the location-based user interface.

15. An apparatus of claim 11, wherein the apparatus is further caused to:
receive a request from the at least one user to calculate at least one route; and
cause, at least in part, a calculation of the route based, at least in part, on the user experience information.

16. An apparatus of claim 11, wherein the apparatus is further caused to:
determine at least one recommendation of one or more other points based, at least in part, on the user experience information, the at least one point of interest associated with the user experience information, or a combination thereof.

17. An apparatus of claim 11, wherein the interaction information, the user experience information, the presentation of the at least one representation in the location-based user interface, or a combination thereof is based, at least in part, on contextual information; and wherein the contextual information includes, at least in part, temporal information, activity information, presence information of at least one other user, or a combination thereof.

18. A computer-readable storage medium carrying one or more sequences of one or more instructions which, when executed by one or more processors, cause an apparatus to at least perform the following steps:
determining interaction information for at least one user, wherein the interaction information is associated with at least one point of interest;
processing and/or facilitating a processing of the interaction information to determine user experience information with respect to the at least one point of interest;
determining one or more rendering characteristics for at least one representation of the at least one point-of-interest based, at least in part, on the user experience information; and
causing, at least in part, a presentation of the at least one representation of the at least one point-of-interest in a location-based user interface using the one or more rendering characteristics.

19. A computer-readable storage medium of claim 18, wherein the apparatus is further caused to perform:
receiving the interaction information by at least one user input in the location-based user interface, one or more interactions with at least one service or at least one application executing on at least one device associated with the at least one user, or a combination thereof.

20. A computer-readable storage medium of claim 19, wherein the at least one user input includes at least one gesture interaction, wherein the at least one gesture interaction that is an upward swipe gesture performed on the at least one representation indicates a like input for the user experience information, and wherein the at least one gesture interaction that is a downward swipe gesture that is performed on the at least one representation indicates a dislike input for the user experience information.
